(19) United States
(12) Patent Application Publication
(10) Pub. No.: US 2007/0010925 A1
(43) Pub. Date: Jan. 11, 2007

(54) Construction target indicator device

(75) Inventors: Yuki Yokoyama, Kanagawa (JP); Masato Kageyama, Kanagawa (JP); Yuki Yokoyama, Kanagawa (JP); Masato Kageyama, Kangawa (JP); Keisuke Miyata, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KOMATSU LTD., Tokyo (JP)

(21) Appl. No.: 10/554,400

(22) PCT Filed: Sep. 1, 2004
(86) PCT No.: PCT/JP04/12642

§ 371 Date: Oct. 24, 2005

(30) Foreign Application Priority Data
Sep. 2, 2003 (JP) 2003-309984

(51) Int. Cl. G06F 19/00

(52) U.S. Cl. 701/50; 37/413

(57) ABSTRACT

A construction target indicator device 30 presents information to the operator of a construction machine 1 in order to facilitate the operation thereof. In the construction target indicator device 30, a laser distance measurement device 20 disposed in the operator's cabin of the construction machine 1 automatically measures the real-time positions of a construction surface 15, reference markers 17 and a bucket 6. A calculation device 32 calculates the cross-sectional shapes of the construction surface 15 and the bucket 6, calculates a virtual line corresponding to a target sloped surface, and creates an image which depicts the cross-sectional shapes of a construction surface 15 and a bucket 6, and a virtual line. The display device 34 displays this image on the display screen. The operator is able to perform accurate excavation work by moving the bucket 6 in line with the virtual line on the display image.

### TECHNICAL FIELD

The present invention relates to a construction target indicator device which can be used in the work of excavating a construction surface, and the like, performed by a work machine such as a hydraulic shovel, or the like.

### BACKGROUND ART

Conventionally, for example, in a construction site, reference markers known as “finishing stakes” or “finishing guides” (in other words, a provisional device, such as a post, or a cord stretched between posts, which marks a reference surface or line) are provided in order to indicate the location at which excavation work is to be performed, to a work machine, such as a hydraulic shovel. The work machine is adjusted in the vertical direction by aligning the base or the blade tip of the bucket section of the hydraulic shovel with the reference marker. However, in a conventional construction method, as the bucket moves away from the reference marker, the target becomes more difficult to perceive and positional shifting from the target position may arise, leading to problems of reduced accuracy of execution.

In order to resolve this problem, it is possible to make the work machine move in a linear direction by means of a standard lever operation, and proposals have been made which disclose a work machine operation device (see Japanese Patent Laid-open No. 5-295754) which allows simple switching between work machine operation based on a speed which is approximately proportional to the amount of displacement of the lever and fine operation, and a sloped face excavation control device for performing excavation work by providing an external horizontal reference (see Domestic Re-publication of International Publication No. WO98/036131).

As shown in FIG. 1, in the work machine operation device disclosed in Japanese Patent Laid-open No. 5-295754, when a mode changeover switch 44 connected to changeover switching devices 41-43 provided inside a control device 40 is operated, the output signals of laser displacement sensors 45 and 46 are input to a linear mode control section 47, and a control instruction signal from the linear mode control section 47 is output to a boom drive system 48, an arm drive system 49 and a bucket drive system 50. By this means, it is possible to drive the rotational fulcrum of the bucket, or the blade tip of the bucket, in a linear direction.

In the work machine operation device disclosed in Japanese Patent Laid-open No. 5-295754, it is possible to implement an arc mode control system in which the direction of operation and the amount of operation of operating levers 51 and 52 can be made to correspond to a swinging motion of the respective elements constituting the work machine, and a linear mode control system in which the rotational fulcrum of the bucket or the blade tip of the bucket is moved linearly in the upward/downward direction or forward/rearward direction, on the basis of the direction of operation and the amount of operation of the operating levers 51 and 52. Furthermore, it is also possible to change between the aforementioned two control systems, simply by operating a mode changeover switch.

Therefore, it is not necessary to provide a special additional operating system in order to achieve linear control of the work machine, and linear control can be achieved by means of normal lever operations which are commonly used in conventional operation. Furthermore, in linear mode, it is possible to cause the rotational fulcrum of the bucket or the blade tip of the bucket to move in the upward/downward direction or the forward/rearward direction, by means of a normal work machine operation. Therefore, the speed of the work machine can also be adjusted in a stepless fashion, without creating any strange sensation in the operation of the lever, and hence the work machine can be adapted readily to horizontal excavation or vertical excavation tasks using linear mode, which occur with high frequency, by means of an extremely simple operation procedure. Consequently, an advantage is obtained in that work efficiency can be improved.

Furthermore, as shown in FIG. 2, in the sloped surface excavation control device disclosed in Domestic Re-publication of International Publication No. WO98/036131, an external reference 60 is provided following the direction of extension of the target slope, and the vertical distance hry and the horizontal distance hrx from the external reference 60 to a reference point on the target slope, as well as the angle Or of the target slope, are set by means of an operating device located in the operator's cabin. By turning on the external reference setting switch when the front reference 61 provided at the front edge of the bucket coincides with the position of the external reference, the control unit calculates the vertical distance hfy and the horizontal distance hfx from the center of the vehicle O to the external reference, and taking these as correctional values, it calculates the vertical distance hsy and the horizontal distance hsx of the reference point on the target slope from the center of the vehicle O. On the basis of these values and an angle input via a setting device, a target slope referenced with respect to the vehicle 62 is established and hence excavation can be controlled to within a limited region. By this means, it is possible to excavate a sloped face without steps, even if the positional relationship between the vehicle and an existing inclined surface changes due to lateral movement of the vehicle.

### DISCLOSURE OF THE INVENTION

The work machine operation device disclosed in Japanese Patent Laid-open No. 5-295754 enables linear control of a work machine, but it requires installation of a boom angle sensor, an arm angle sensor, and a bucket angle sensor, respectively, on the moving parts of the work machine, in order to achieve linear control. Furthermore, in the sloped surface excavation control device disclosed in Domestic Re-publication of International Publication No. WO98/036131, the task of situating an external reference 60 accurately in a horizontal position is complicated, and the bucket reference 61 and the external reference 60, which are located at a distant position from the machine operator, must be aligned in position to a high degree of accuracy based on visual judgment. Therefore, the operation is not simple to carry out.

The object of the present invention is to provide a device whereby the shape of a construction surface and the position of a reference marker can be measured automatically, and information facilitating the operation of the work machine can be presented to the operator, by means of a simple composition.

The device for giving indications to the operator of a work machine according to the present invention comprises: a measurement device for measuring the position of a construction surface, which is a current work object, and the position of other objects located in the vicinity of construction surface, while the work machine is performing work; a reference point detection unit for detecting reference points corresponding to reference markers disposed in the vicinity of the construction surface, from the positions of the construction surface and the other objects measured by the measurement device; a virtual line calculation unit for calculating a virtual line corresponding to a target surface that is to be formed, on the basis of the reference points detected by the reference point detection unit; a display data creation unit for creating display data for displaying images indicating the positions of at least the construction surface and the virtual line, on the basis of the positions measured by the measurement device and the virtual line calculated by the virtual line calculation unit; and a display device (34) for receiving the display data from the display data creation unit and displaying the images on a display screen. Therefore, an image indicating the position of a construction surface, which is the current work object, and the position of a virtual line corresponding to a target surface that is to be formed, are displayed on the display screen. Since the operator of the work machine can tell the positional relationship between the construction surface and the target surface, from the displayed image, he or she is able readily to judge the extent of the machining that is to be applied to the construction surface by operating the work machine.

The position of the other objects in the vicinity of the construction surface which are detected by the measurement device may also be displayed, together with the construction surface and the virtual line. The other objects thus detected generally include, for example, reference markers which are disposed in the vicinity of the construction surface, an acting component which acts directly on the construction surface worked by the work machine (for example, an excavation bucket in the case of a hydraulic shovel), and the like. Since human beings have an extremely high capacity to recognize patterns, the operator can readily identify, by looking at the displayed image, which part of the display images corresponds to the acting component, which part corresponds to the construction surface, and which part corresponds to the virtual line, and hence he or she can readily judge how the work machine should be moved.

In a preferred embodiment, the cross-sectional shapes of the construction surface and the other objects detected by the measurement device (such as the reference markers, acting components, and the like), are calculated, and a virtual line is also calculated, in such a manner that an image depicting the cross-sectional shapes of the construction surface and the other objects, as well as the virtual line, is displayed on the display screen.

The measurement device may be disposed in such a manner to move or turn direction in unison with the work machine, when the work machine moves or turns direction. Thereby, even if the construction surface moves due to the work machine moving or turning direction, the current positions of the construction surface and the other objects located in the vicinity of the construction surface are measured constantly and the current position of the construction surface and the virtual line are displayed on the display screen.

The measurement device may determine the positions of the construction surface and the other objects on a continuous basis. Thereby, the positions of the construction surface and the virtual line are shown on the display screen, substantially in real time, while the work machine is performing work.

The reference point detection unit may automatically detect a position satisfying prescribed geometrical conditions, from the positions of the construction surface and other objects measured by the measurement device, as a reference point, or the reference point detection unit may detect a position specified by the operator, from the positions of the construction surface and other objects measured by the measurement device, as a reference point.

The reference point detection unit may also detect a plurality of positions as the reference points, in such a manner that a virtual line passing-through this plurality of reference points is calculated.

The indicator device according to the present invention may further comprise an acting component detection unit for detecting the position of the aforementioned acting component of the work machine. The position of the acting component may be displayed on the display screen, together with the positions of the construction surface and the virtual line, on the basis of position of the acting component thus detected.

As a method for detecting the position of the acting component, it is possible to adopt a method whereby the position corresponding to the acting component is detected from the positions of the construction surface and other objects measured by the measurement device, by means of pattern matching, a regional judgment process, or the like. Alternatively, the displacement of a plurality of components of the work machine may be measured by displacement sensors installed on respective components, and the displacement of the acting component can be determined from the displacement of the plurality of components thus measured.

Furthermore, the position of the acting component thus detected may be corrected by means of a prescribed offset amount, and the corrected position of the acting component may be displayed together with the positions of the construction surface and the virtual line. In a preferred embodiment, the positions of the inner surfaces of an excavation bucket, which forms the acting component of a hydraulic shovel, are measured by means of a measurement device, these positions of the inner surfaces are corrected by means of an offset corresponding to the thickness of the excavation bucket, in such a manner that they correspond approximately to the positions of the outer surfaces of the excavation bucket, and the positions of the inner surfaces of the excavation bucket thus corrected are displayed together with the construction surface and the virtual line. Thereby, the operator is able to ascertain the position of the acting component, accurately.

A display showing an enlarged, or emphasized, view of the positional error between the construction surface and the virtual line may also be shown in response to a request from the operator. Accordingly, the operator can readily operate the work machine even more accurately.

The device for giving indications to the operator of a construction machine having a work machine according to a further aspect of the present invention comprises: a measurement device installed on the construction machine in such a manner that it moves or turns direction in unison with the work machine, if the construction machine moves or the work machine turns direction, which measures the positions of the construction surface forming the current work object and other objects located in the vicinity of the construction surface, while the work machine is performing work; a reference point detection unit for detecting reference points corresponding to reference markers disposed in the vicinity of the construction surface, from the positions of the construction surface and the other objects measured by the measurement device; a virtual line calculation unit for calculating a virtual line corresponding to a target surface that is to be formed, on the basis of the reference points detected by the reference point detection unit; a display data creation unit for creating display data for displaying images indicating the positions of at least the construction surface and the virtual line, on the basis of the positions measured by the measurement device and the virtual line calculated by the virtual line calculation unit; and a display device for receiving the display data from the display data creation unit and displaying the images on a display screen.

The method for giving indications to the operator of a work machine according to yet a further aspect of the present invention comprises the steps of: measuring the position of a construction surface, which is a current work object, and the position of other objects located in the vicinity of the construction surface, while the work machine is performing work; detecting reference points corresponding to reference markers disposed in the vicinity of the construction surface, from the measured positions of the construction surface and the other objects; calculating a virtual line corresponding to a target surface that is to be formed, on the basis of the detected reference points; and creating an image indicating the positions of at least the construction surface and the virtual line, on the basis of the measured position and the calculated virtual line, and displaying the image on the display screen.

### BRIEF DESCRIPTION OF THE DRAWINGS

FIG. 1 is an approximate composition diagram of a work machine drive system according to the prior art;

FIG. 2 is an approximate diagram showing a working state according to a prior art example;

FIG. 3 is a perspective diagram showing one example of a situation where a sloped surface is excavated by means of a hydraulic shovel;

FIG. 4 is a block diagram showing the composition of a construction target indicator device according to one embodiment of the present invention as installed in a hydraulic shovel;

FIG. 5 is a block diagram showing the functional composition of a calculation device 32 in a construction target indicator device;

FIG. 6 is a diagram showing a method for detecting the perpendicular coordinates of a certain object point, using a laser distance measurement device;

FIG. 7 is a diagram showing an example of the cross-sectional image of a construction surface displayed on a display screen;

FIG. 8 is a diagram showing a method for establishing a first reference point;

FIG. 9 is a diagram showing a method for establishing a second reference point;

FIG. 10 is a diagram showing a method for setting a virtual line;

FIG. 11 is a diagram showing the sequence of processing for establishing a virtual line by automatically detecting reference points;

FIG. 12 is a diagram showing the sequence of processing for correcting the shape of a bucket by automatically detecting the bucket;

FIG. 13 is a diagram showing the sequence of pattern matching;

FIG. 14 is a diagram showing a display example of a cross-sectional image of the terrain;

FIG. 15 is a diagram showing an example in which a portion of the cross-sectional image of the terrain is depicted in an emphasized manner;

FIG. 16 is a diagram showing an algorithm for creating an emphasized display of the cross-section of the terrain;

FIG. 17 is a diagram for describing an algorithm for creating an emphasized display of the cross-section of the terrain; and

FIG. 18 is a diagram for describing an algorithm for creating an emphasized display of the cross-section of the terrain.

### BEST MODE FOR CARRYING OUT THE INVENTION

Preferred embodiments of the present invention are described in concrete terms below, with reference to the accompanying drawings.

### First Embodiment

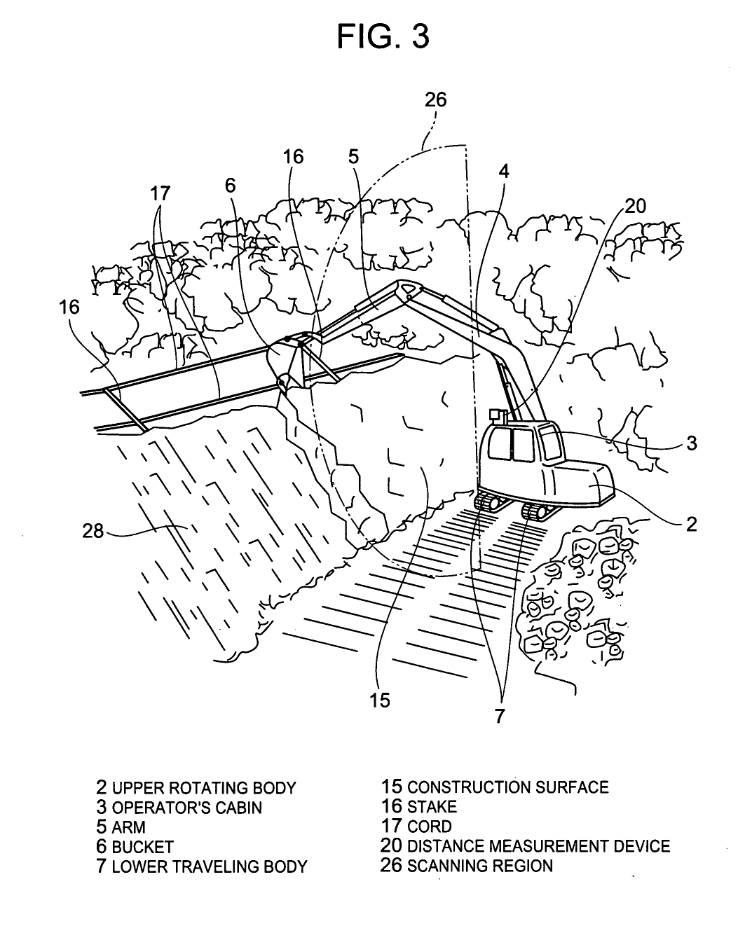

FIG. 3 is a perspective diagram showing an example of a situation where a sloped surface is being excavated by a construction machine, for example, a hydraulic shovel, which is equipped with a first embodiment of a construction target indicator device according to the present invention. In the near-side region of the work site illustrated in FIG. 3, excavation by means of the hydraulic shovel 1 has already been completed and a sloped surface 28 has been formed. In far-side region of the current work site, there exists, below the bucket 6, a construction surface 15 which is the object of the current excavation task. Reference markers (such as a plurality of posts 16, and a pair of cords 17 stretched between the cords 16, or the like, commonly known as “stakes”) have previously been disposed adjacently above the construction surface 15. The plane passing through these reference markers, and particularly, through the pair of cords 17, indicates the target sloped surface that is to be formed by excavation. In other words, a pair of cords 17 are disposed in the plane of extension of the target sloped surface.

The hydraulic shovel 1 comprises a lower traveling body 7 for moving the hydraulic shovel 1, and an upper rotating body 2 which can change direction (turn) in the horizontal direction, disposed above the lower traveling body 7. The upper rotating body 2 comprises an operator's cabin 3 and a work machine. The work machine comprises a boom 4, an arm 5 attached to the front end of the boom 4, and a bucket 6 attached to the front end of the arm 5. The boom 4, arm 5 and bucket 6 are driven by respective hydraulic cylinders. The operator is able to excavate a construction surface 15 accurately, by causing the bucket 6, which is the component that acts directly on the construction surface 15 of the work machine, to move in line with the target plane indicated by the reference markers 16 and 17.

A distance measurement device 20, which is one section of the construction target indicator device according to the present invention, is attached to the upper part of the operator's cabin 3 of the hydraulic shovel 1. By rotation of the upper rotational body 2, the distance measurement device 20 rotates in unison with the operator's cabin 3 and the work machine. When the hydraulic shovel 1 is moved, the distance measurement device 20 moves in unison with the hydraulic shovel 1. A laser distance measurement device may be used as the distance measurement device 20, for example. This laser distance measurement device (distance measurement device 20) irradiates a laser beam in a direction equivalent to the straight forward direction from the operator's cabin 3, according to the angle of horizontal rotation, and by continuously changing the angle of elevation of the laser beam at a prescribed cycle, it continuously scans the laser beam through a scanning region 26 which broadens in the forward direction from the operator's cabin 3. The construction surface 15 which is the current object of the excavation work is located within the scanning region 26. Furthermore, the reference markers 16 and 17 adjacent to the construction surface 15, and the bucket 6, are also located within the scanning region 26. This laser distance measurement device (distance measurement device 20) receives the laser beam reflected by the construction surface 15, the reference markers 16 and 17 and the bucket 6 situated within the scanning region 26, and it then measures the positions of the various parts of these objects (in other words, the distance and angle of elevation thereof). The measurement data output by the laser distance measurement device (distance measurement device 20) which indicates the position (distance and angle of elevation) of the various parts of the construction surface 15 and the other objects (the reference markers 16 and 17, the bucket 6, and the like) situated within the scanning region 26, is processed by means of the construction target indicator device according to the present invention.

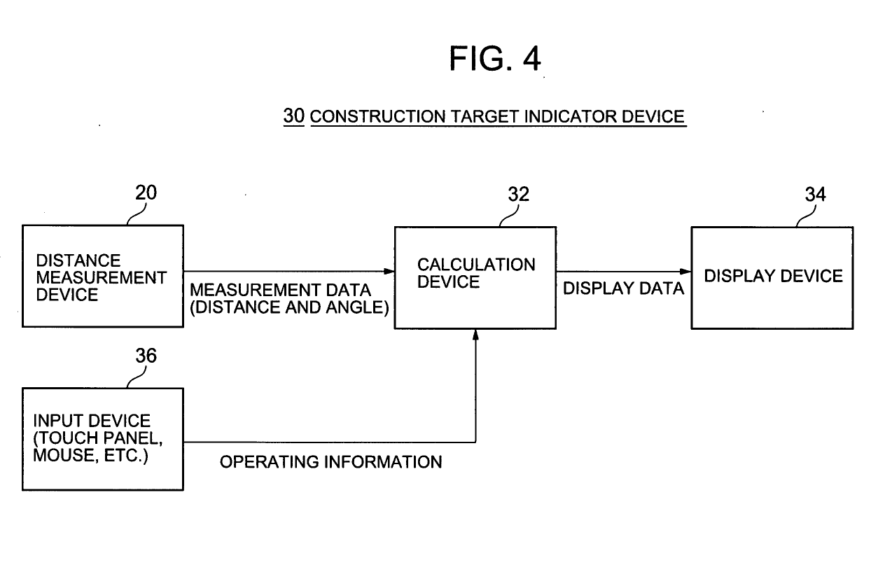

FIG. 4 shows the composition of one embodiment of a construction target indicator device according to the present invention, which is installed in the hydraulic shovel 1.

As shown in FIG. 4, the construction target indicator device 30 comprises the aforementioned distance measurement device (laser distance measurement device) 20, a calculation device 32, a display device 34, and an input device 36. As described above, the distance measurement device 20 (laser distance measurement device) outputs measurement data indicating positional information (distance and angle of elevation) of the various parts of the construction surface 15, the reference markers 16 and 17 and the bucket 6, which are situated in the scanning region 26, to the calculation device 32.

The calculation device 32 can be realized by means of a computer comprising, for example, a storage device storing a program and a CPU which executes that program. The calculation device 32 calculates the cross-sectional shapes (outline shapes) of the construction surface 15, the reference markers 16 and 17 and the bucket 6 in the vertical plane, on the basis of the positions (distance and angle of elevation) of the various parts of the construction surface 15, the reference markers 16 and 17 and the bucket 6 indicated by the measurement data supplied by the distance measurement device 20. The calculation device 32 creates display data which represents an image of the cross-sectional shapes of the construction surface 15, the reference markers 16 and 17 and the bucket 6, from the cross-sectional data for the construction surface 15, the reference markers 16 and 17 and the bucket 6 thus calculated. The calculation device 32 outputs this display data to the display device 34. The display device 34 is, for example, a liquid-crystal display panel, which is located inside the operator's cabin 3 in a position where it is readily visible to the operator. The display device 34 displays an image of the cross-sectional shape of the construction surface 15, the reference markers 16 and 17 and the bucket 6, in response to the display data.

The cross-sectional shape of the bucket 6 displayed on the display device 34 is generally the cross-sectional shape of the inner side of the bucket 6, rather than the outer side. The reason for this is that the inner side, rather than the outer side, of the bucket 6 is facing toward the distance measurement device 20 on the operator's cabin 3. However, since it is the outer side of the bucket 6, rather than the inner side, which performs the excavation work, then desirably, the cross-sectional shape of the outer side of the bucket 6, rather than the inner side, is displayed on the display screen. Therefore, the calculation device 32 is able to display an image of the cross-sectional shape of the bucket 6 on the display screen, at the positions where the outer faces of the bucket 6 are located, by shifting the positions of the inner side of the bucket 6 outwards through an offset amount corresponding to the thickness of the bucket 6.

The input device 36 is a pointing device by means of which the operator can specify a desired section of the cross-sectional shape image of the construction surface 15, the reference markers 16 and 17 and the bucket 6 displayed on the display screen. For the input device 36, it is possible, for example, to use a touch panel incorporated into the display screen of the display device 34, or a mouse which controls a cursor displayed on the display screen, or the like.

The distance measurement device 20 is not limited to being a laser distance measurement device as described above. Various other types of devices which can automatically measure the cross-sectional shape and position of the construction surface 15 and objects in the vicinity thereof may also be used as the distance measurement device 20. For example, a distance measurement device which determines the distance by issuing a sound wave, or the like, may be used. Alternatively, it is also possible to use a device which determines the cross-sectional shape of the construction surface by means of an optical method other than laser-based distance measurement. Furthermore, it is also possible to use a device which acquires information for a plurality of images viewing the construction surface from different viewpoints by means of one or a plurality of cameras, and determines the cross-sectional shape of the construction surface from this image information.

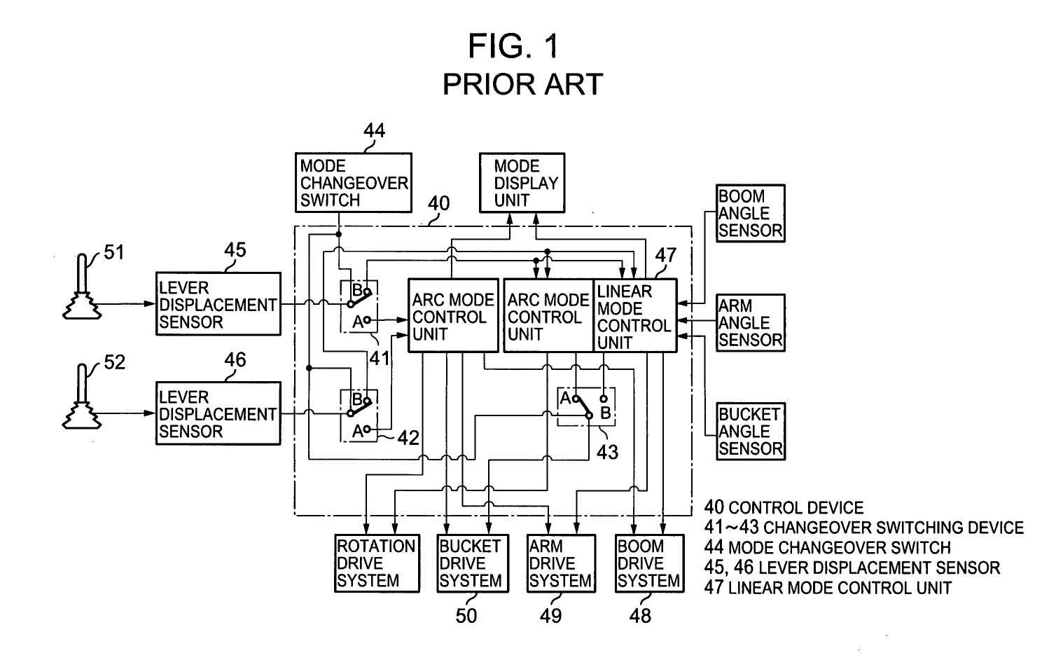

The position of installation of the distance measurement device 20 is not limited to the upper part of the operator's cabin 3 as illustrated in FIG. 1. The distance measurement device 20 may also be installed inside the operator's cabin 3 or at a suitable position on the upper rotating body 2. In any of these cases, the distance measurement device 20 rotates in unison with the upper rotating body 2 and travels in unison with the hydraulic shovel 1. The distance measurement device 20 continuously performs a scan in the scanning region 26, at prescribed intervals, and determines substantially real-time measurements for the positions of the construction surface 15, the reference markers 16 and 17 adjacent to same, and the bucket 6. Consequently, images of the cross-sectional shapes of the construction surface 15, the reference markers 16 and 17 and the bucket 6 are displayed, substantially in real time, on the display screen. Either at the start of excavation work, or during excavation work, or after the end of excavation, the operator is able to confirm, readily by means of the display screen, whether or not the current position of the bucket 6 is suitable, whether or not the excavation work is being carried out accurately, and the like.

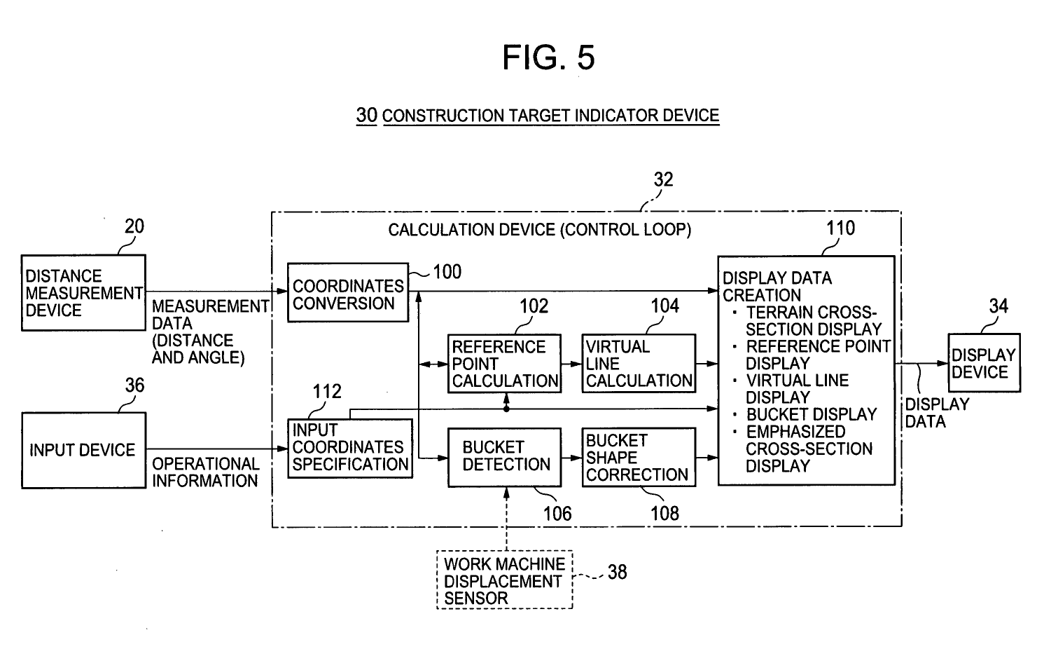

FIG. 5 shows the functional composition of the calculation device 32 of the construction target indicator device shown in FIG. 4.

As shown in FIG. 5, the calculation device 32 comprises a coordinates conversion unit 100, a reference point detection unit 102, a virtual line calculation unit 104, a bucket detection unit 106, a bucket shape correction unit 108, a display data creation unit 110, and an input coordinates specification unit 112. The functional units 100. 112 of the calculation device 32 may be realized by means of a CPU executing program, or they may be realized by means of wired hardware.

The coordinates conversion unit 100 converts the positions (distance and angle of elevation) of the respective parts of the construction surface 15, the reference markers 16 and 17 and the bucket 6, supplied by the distance measurement device 20 (laser distance measurement device), into coordinate values for a perpendicular coordinates system (namely, an X coordinate value and a Y coordinate value). The origin of the perpendicular coordinates system is set at a prescribed relative position with respect to the hydraulic shovel 1 (for example, the position at which the distance measurement device 20 is installed, the position of the operator's seat in the operator's cabin 3, the center point of the hydraulic shovel 1, or the like).

The reference point determination unit 102 determines the coordinate values of a plurality of points (for example, two points) (hereinafter, called “reference points”.) which correspond to the reference markers (and in particular, to the pair of cords 17), from the center of the coordinate points of each part of the construction surface 15, the reference markers 16 and 17 and the bucket 6 supplied by the coordinate conversion unit 100. This determination process may be carried out automatically, or it may be performed manually in accordance with coordinates specified by the operator by means of the input device 36. The virtual line calculation section 104 calculates a virtual line representing the cross-sectional shape of the target sloped surface which is to be formed by the excavation work, on the basis of the plurality of reference points detected by the reference point detection unit 102.

The bucket detection unit 106 automatically detects the group of coordinate values corresponding to the bucket 6 from the coordinate values of the respective parts of the construction surface 15, the reference markers 16 and 17 and the bucket 6 supplied by the coordinates conversion unit 100. This detection process may be performed using a method such as pattern matching, for example, principally on the basis of the coordinate values from the coordinates conversion unit 100, or alternatively, it may be performed by using detection signals from displacement sensors 38 which are provided respectively on the plurality of components of the work machine (namely, the boom 4, arm 5 and bucket 6), and which determine the displacement of the respective components (for example, stroke sensors which detect the strokes of the hydraulic cylinders which respectively move the boom 4, arm 5 and bucket 6. The bucket shape correction unit 108 corrects the coordinate value group of the bucket 6 determined by the bucket detection unit 106 (the coordinate value group which indicates the cross-sectional shape of the inner side of the bucket 6), by shifting the coordinate values outwards through an offset amount corresponding to the prescribed thickness of the bucket 6.

The display data creation unit 110 creates display data for displaying an image of the cross-sectional shape of the construction surface 15, an image of the reference points, an image of a virtual line, and an image of the corrected cross-sectional shape of the bucket 6, on the basis of the coordinate values from the coordinate conversion unit 100, the reference points detected by the reference point detection unit 102, the virtual line calculated by the virtual line calculation unit 104, and the coordinate value group of the bucket 6 which has been corrected by the bucket shape correction unit 108. The display data creation unit 110 outputs this display data to the display device 34.

The display device 34 displays an image representing the cross-sectional shape of the construction surface 15, the reference points, the virtual line, and the corrected cross-sectional shape of the bucket 6, in response to this display data. This display image clearly indicates the positional relationship between the construction surface 15, the reference points, the virtual line and the bucket 6.

As described below, in order that any positional error between the displayed virtual line and the construction surface 15 is readily visible to the operator, the display data creation unit 110 is also able to create display data for an image in which this positional error is enlarged and emphasized, and output this display data to the display device 34.

The input coordinates specification unit 112 specifies the coordinate values of a point designated on the display screen by the operator by means of the input device 36. If the reference points are detected manually, for example, then the coordinate values specified by the input coordinates specification unit 112 are input to the reference point detection unit 102 as the coordinate values of the reference point designated by the operator. Furthermore, if the positional error between the displayed virtual line and the construction surface 15 is to be displayed in an emphasized fashion, for example, then the coordinate values specified by means of the input coordinates specification unit 112 are input to the display data creation unit 110 as coordinate values specifying the region of the display image that is to be displayed in an emphasized fashion.

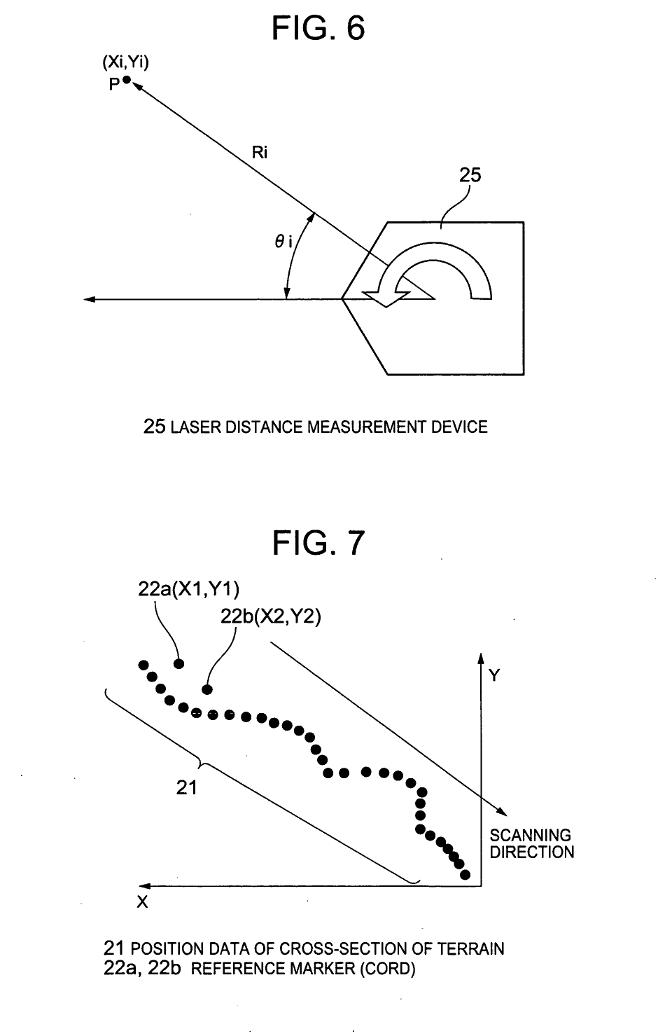

FIG. 6 shows a method in which the coordinates conversion unit 100 shown in FIG. 5 converts the distance and angle of elevation from the laser distance measurement device 25 into perpendicular coordinate values.

As shown in FIG. 3, from the distance Ri and the angle of elevation θi from the object point P measured by the laser distance measurement device 25, it is possible to determine the perpendicular coordinates (Xi, Yi) of the object point P by means of the calculation formula:
(Xi, Yi)=(Ri·cos θi, Ri·sin θi)

FIG. 7 shows one example of an image displayed on the display screen. In FIG. 7, the display of an image of the cross-sectional shape of the bucket 6 is omitted from the drawing.

In the display image shown in FIG. 7, the curved line 21 consisting of a consecutive plurality of dots shows the line of the terrain in the cross-sectional shape of the construction surface 15. The two separate dots 22a and 22b which are isolated from this terrain line 21 is an image of the pair of cords 17 which form the reference markers illustrated in FIG. 1. Furthermore, it should be noted that the direction indicated by the arrow in the diagram is the scanning direction of the laser distance measurement device 25, but this scanning direction is not limited to the direction of the arrow in the diagram, and may also be the opposite direction to that of the arrow, or a reciprocal direction.

As shown in FIG. 7, an X axis and a Y axis are depicted in such a manner that the image of the cross-sectional shapes is positioned in the second quadrant of the perpendicular coordinates system. This means that an image of the cross-sectional shapes is displayed as if observing the construction surface 15 from the left-hand side in the work site shown in FIG. 1. For example, by operating a display direction changeover switch (not illustrated) which is attached to the display device 34, it is possible to invert the viewpoint from which the cross-section is observed, from the left-hand side to the right-hand side (in other words, an image which is symmetrical to the image in FIG. 7 with respect to the Y axis may be displayed in the first quadrant).

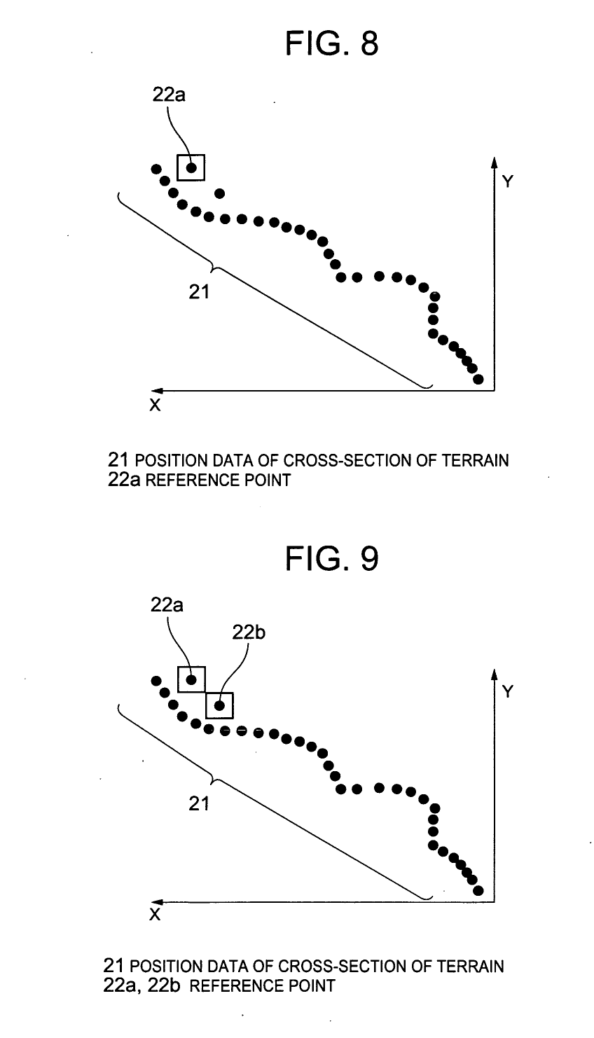

FIG. 8 to FIG. 10 illustrate a procedure by which the reference point detection unit 102 and the virtual line calculation unit 104 shown in FIG. 5 perform the steps of detecting reference points and establishing a virtual line.

As shown in FIG. 8, one dot 22a corresponding to the reference marker (cord) is detected in the center of the display image, and this is established as a first reference point. Moreover, as shown in FIG. 9, a further dot 22b corresponding to a reference marker (cord) is detected and this dot is established as a second reference point. The reference point may be detected manually. In other words, if the operator designates a point corresponding to the reference marker (cord), on the display image, by using the input device 22 (for example, a touch panel sensor incorporated into the display screen, a mouse which controls a cursor displayed on the display screen, or the like), then the coordinate values of this point are registered as the coordinates of the reference point by the reference point detection unit 102. Furthermore, as described hereafter, it is also possible to perform the detection of the reference point automatically.

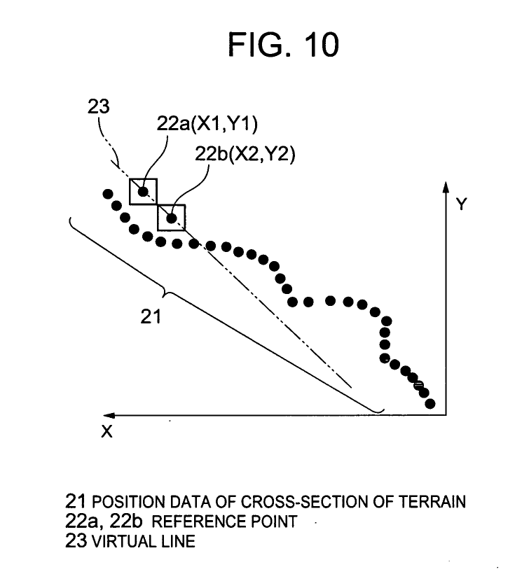

When the two reference points 22a and 22b have been established, the virtual line calculation unit 104 calculates a virtual line 23 on the basis of the coordinate values (X1, Y1), (X2, Y2) of the reference points 22a and 22b, as shown in FIG. 10, by means of the calculation formula:
Y−Y1=(X−X1)·(Y2−Y1)/(X2−X1)

In other words, the virtual line 23 is a straight line passing through the reference points 22a and 22b, and as described above, this shows the position, in other words, the cross-sectional shape, of the target sloped surface that is to be formed by excavation. Thereupon, as shown in FIG. 9, an image of the reference points 22a and 22b and the virtual line 23 is displayed on the display screen, together with the line of the terrain 21 in the cross-sectional shape of the construction surface 15. The reference points 22a and 22b, the virtual line 23 and the terrain line 21 can be displayed in different colors, for example, in order to make them more readily distinguishable.

The method for calculating the virtual line is not limited to a method for calculating a straight line passing through the two reference points, as described above. For example, it is also possible to calculate the virtual line on the basis of one reference point and a previously established reference angle. In order that the input operation for the series of tasks described with respect to FIG. 8 to FIG. 10 can be carried out readily, it is also possible for the calculation device 32 to output guidance messages which indicate the input operating procedure to the display screen.

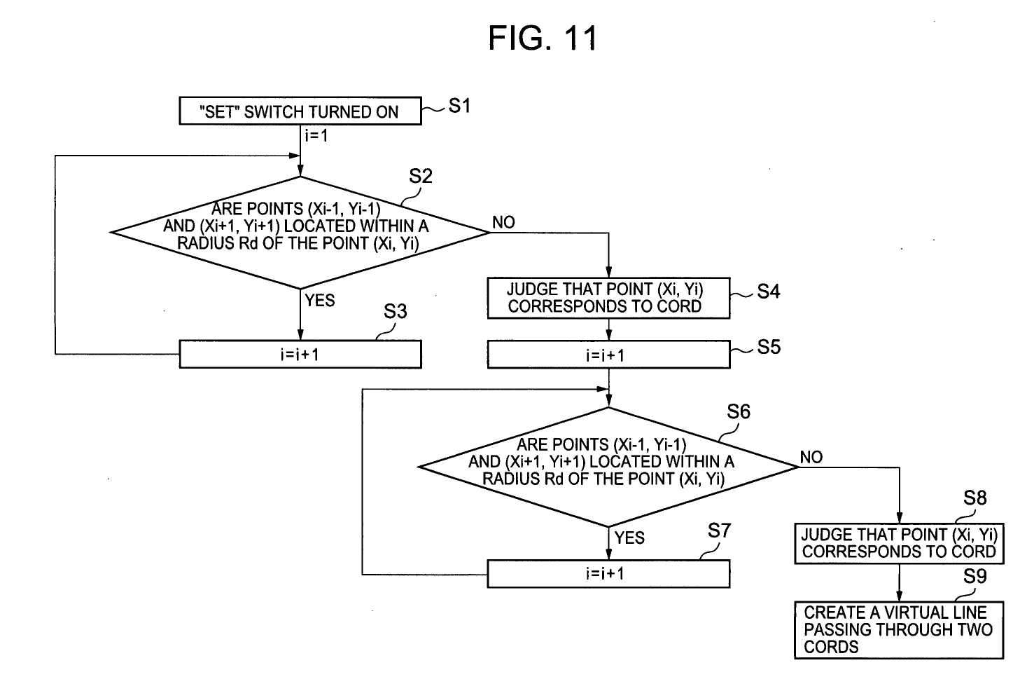

The processing involved in the reference point detection and virtual line setting illustrated in FIG. 8 to FIG. 10 may also be designed so as to be performed entirely automatically, without depending on manual specification of reference points by the operator. FIG. 11 shows a flow of this automatic processing. The processing shown in FIG. 11 picks out, as a reference point, a position which satisfies prescribed geometrical conditions (for example, a position which is separated and isolated from the group of other positions), from the positions of the detection objects, such as the construction surface 15, the reference markers 16 and 17, and the like, measured by the distance measurement device 20.

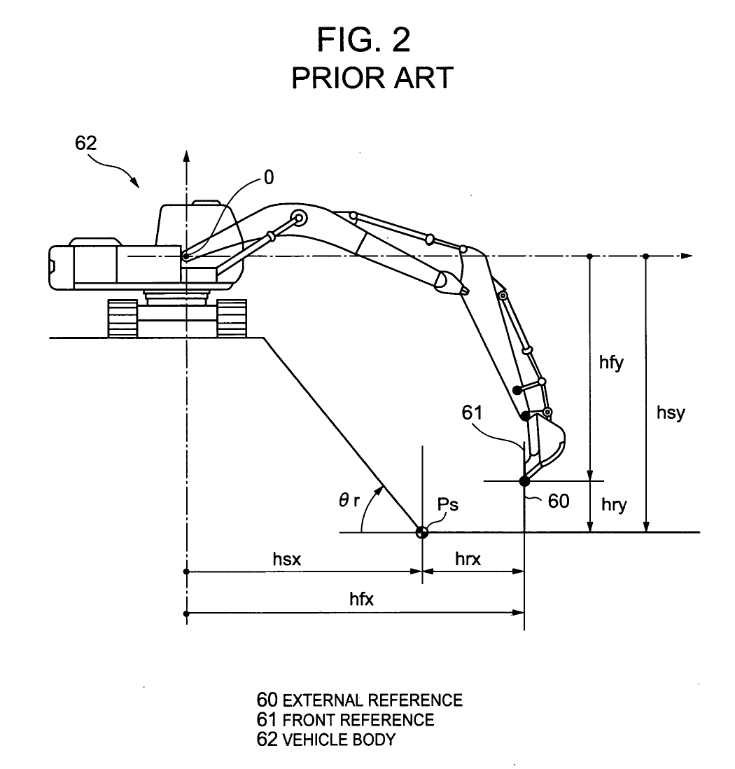

After an image of the cross-sectional shape of the detection object has been displayed on the display screen, as illustrated in FIG. 7, at step S1 in FIG. 11, a setting switch (not illustrated) attached to the display device 34 is turned on by the operator, for example. When the “setting” switch is turned on, the reference point detection unit 102 shown in FIG. 2 is started up, and the reference point detection processing in steps S2 to S8 is implemented, by taking an initial value of i=1. At step S2, one set of coordinates (Xi, Yi) at the ith position scanned in the scanning sequence is selected from the group of coordinates converted by the coordinates conversion unit 100, and it is judged whether or not the set of coordinates in the previous scan in the scanning sequence (Xi−1, Yi−1), or the set of coordinates in the subsequent scan (Xi+1, Yi+1), are located within a radius Rd centered on the selected coordinates. (Xi, Yi). If both the coordinates in the previous scan and the coordinates in the following scan are located within a radius Rd centered on the selected coordinates (Xi, Yi), then it is judged that the selected coordinates (Xi, Yi) correspond to one cord 17 (reference marker) which is separated from the construction surface 15 (step S4). In this way, the detected coordinates of one cord (Xi, Yi) are set as a first reference point.

At step S2, if the coordinates in the previous scan position (Xi−1, Yi−1) or the coordinates in the next scan position (Xi+1, Yi+1) are located within the radius Rd centered on the selected coordinates (Xi, Yi), then it is judged that the selected coordinates (Xi, Yi) correspond to a point on the construction surface 15, and at step S3, i is incremented to i=i+1, and the judgment in step S2 is continued with respect to the coordinates in the next scan position (Xi, Yi).

After setting the first reference point at step S4, an algorithm similar to that in steps S2 and S3 is repeated for the remaining coordinates (steps S6 and S7), and a second reference point corresponding to another cord 17 (reference marker) is detected (step S8).

When the second reference point has been established in step S8, then at step S9, a straight line passing through the two reference points is calculated, and this straight line is displayed on the display screen as a virtual line 23 as shown in FIG. 10.

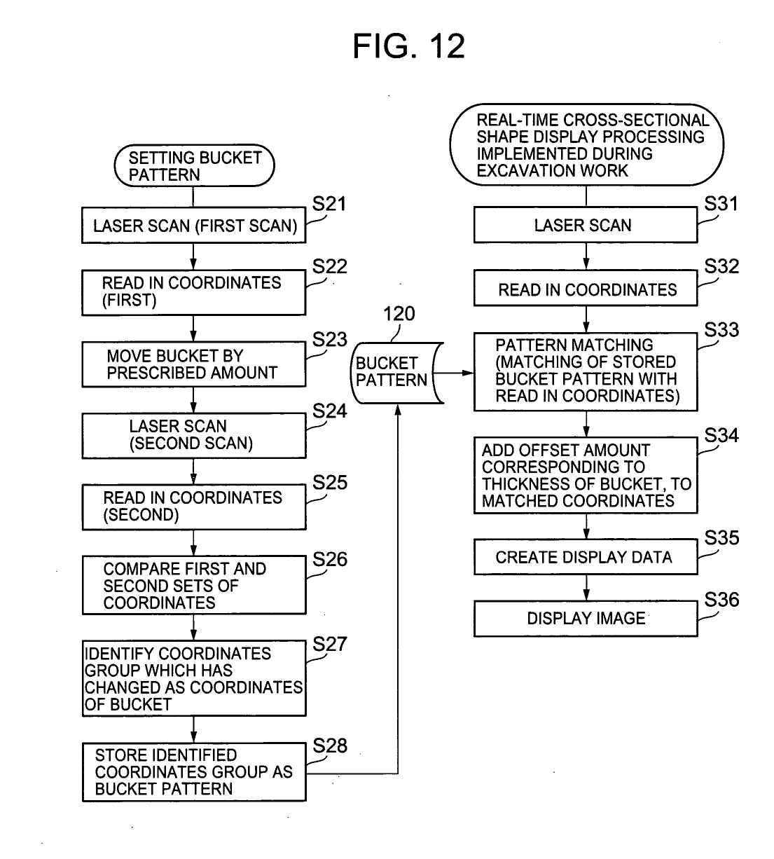

FIG. 12 shows the flow of processing for bucket detection and shape correction performed by the bucket detection unit 106 and the bucket shape correction unit 108 illustrated in FIG. 5.

Before starting the excavation work as illustrated in FIG. 12, processing for setting the shape pattern of the bucket 6 (steps S21 to S28) is carried out.

At step S21, if the bucket 6 is in a suitable position, then a first scan of the scanning region 26 is performed by the distance measurement device 20 (laser distance measurement device 25), and at step S22, the coordinates of the construction surface 15, the reference markers 16 and 17 and the bucket 6 measured in the first scan are read in by and stored in the bucket detection unit 106. Thereupon, at step S23, if the bucket 6 is moved through a prescribed distance, then at step S24, a second scan of the scanning region 26 is performed by the distance measurement device 20 (laser distance measurement device 25), and at step S25, the coordinates of the construction surface 15, the reference markers 16 and 17 and the bucket 6 measured by the second scan are read in by and stored in the bucket detection unit 106.

At step S26, the coordinates measured in the first and second scans are compared. At step S27, the group of coordinates which have changed as a result of the comparison are recognized as corresponding to the bucket 6, and at step S28, the group of coordinates recognized as corresponding to the bucket 6 are stored as a bucket pattern 120 representing the shape of the bucket 6. With this, the process of setting the bucket pattern is completed.

During the execution of excavation work, the real-time cross-sectional shape display processing in steps S31 to S36 in FIG. 12 is performed repeatedly at a prescribed high rate of frequency.

At step S31, the scanning region 26 is scanned by the distance measurement device 20 (laser distance measurement device 25) and at step S32, the coordinates of the construction surface 15, the reference markers 16 and 17 and the bucket 6 measured in that scan are read in by and stored in the bucket detection unit 106. At step S33, pattern matching is performed between a previously established bucket pattern 120 and the coordinates that have been read in. By this means, a group of coordinates which match the bucket pattern 120 to a relatively high degree of matching are extracted as coordinates corresponding to the bucket 6.

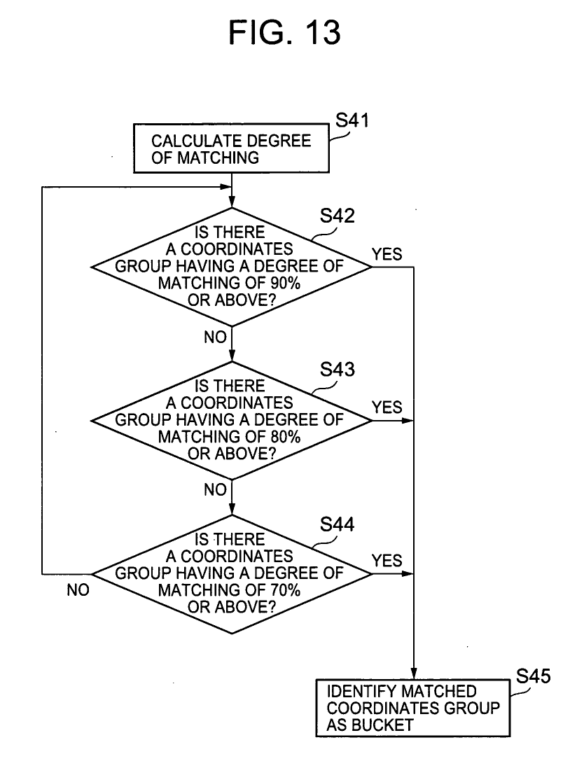

This pattern matching can be performed by means of a procedure such as that illustrated in FIG. 13, for example. In other words, at step S41 in FIG. 13, the degree of matching between the respective groups of coordinates that have been read in, and the bucket pattern 120, is calculated. At step S42, a search is made for a group of coordinates having a degree of matching of 90% or above. If a coordinates group of this kind cannot be found, then at step S43, a search is made for a group of coordinates having a degree of matching of 80% or above. If a coordinates group of this kind cannot be found, then at step S44, a search is made for a group of coordinates having a degree of matching of 70% or above. In this way, the range of matching of a prescribed level and above (for example, 70% and above) is divided into a plurality of stages, and a search is made for a group of coordinates having the corresponding degree of matching, in sequence, starting from the highest stage. Consequently, the coordinates group having the highest degree of matching is determined, preferentially. In addition to this, even if the blade tip of the bucket 6 has been inserted into the earth, then it is still possible to detect the shape of the portion of the bucket 6 projecting from the earth, by means of pattern matching. Moreover, it is also possible to infer whether or not the blade tip of the bucket 6 has been inserted into the earth, on the basis of the degree of matching, and it is also possible to infer the position of the blade tip of the bucket 6 inserted into the earth, from the results of this inference.

Referring again to FIG. 12, at step S34, an offset amount corresponding to the previously established thickness of the bucket 6 is added to the coordinates group of the bucket 6 (which represent the cross-sectional shape of the inside faces of the bucket 6). Thereby, the coordinates group of the inside faces of the bucket 6 are corrected in such a manner that they indicate the general position of the outer faces of the bucket 6.

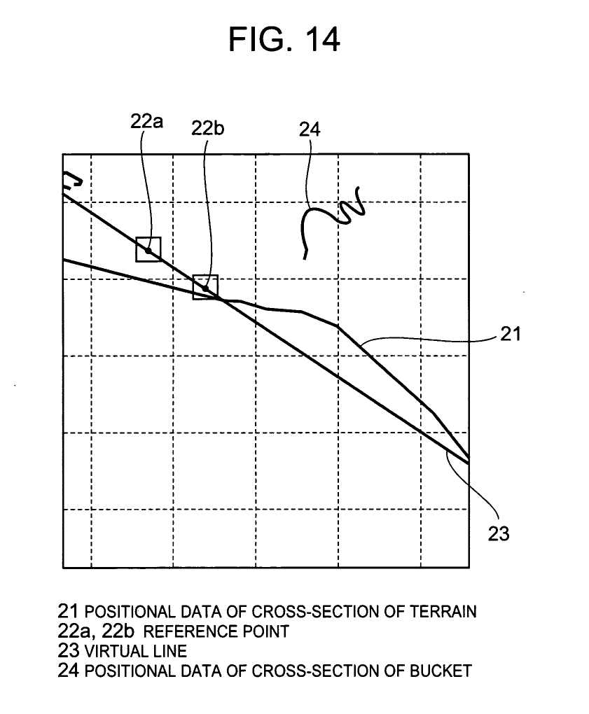

At step S35, display data for displaying images of the cross-sectional shapes are created on the basis of the corrected coordinates of the bucket 6, the measured coordinate values of the construction surface 15, the coordinate values of the detected reference point, and the coordinate values of the established virtual line. At step S36, an image based on the display data is displayed. This display image is such as the example shown in FIG. 14, and the cross-sectional shape 21 of the construction surface 15, the reference points 22a and 22b, the virtual line 23, and the cross-sectional shape 24 of the bucket 6 are shown in this image.

The method for detecting which of the measured coordinate values corresponds to the bucket 6 is not limited to the aforementioned pattern matching, and another method, for example, one of method (1) to method (3) below may also be used instead of, or in conjunction with, pattern matching.

(1) Measurement data located within a prescribed region is regarded as corresponding to the bucket 6. More specifically, in many cases, in the measurement data from the distance measurement device 20 located on the operator's cabin 3, the bucket 6 is located in the upper forward region as viewed from distance measurement device 20. Therefore, the group of coordinates located within the upper forward region is regarded as corresponding to the bucket 6.

(2) The coordinates of the bucket 6 are specified using optical reflectors attached to the work machine. More specifically, optical reflectors are installed previously at particular locations on the work machine (for example, the arm 5 and bucket 6). These optical reflectors are detected on the basis of the measurement data from the distance measurement device 20 (laser distance measurement device), and the coordinates of the bucket 6 are identified on the basis of the relative positions of these optical reflectors.

(3) The coordinates of the bucket 6 are specified using displacement sensors attached to the work machine, which correspond to the plurality of components of the work machine. In other words, data relating to the shape of the bucket 6 and the structure of the work machine (for example, the boom 4, arm 5 and bucket 6), are registered in the calculation device 32 illustrated in FIG. 5. Displacement sensors which determine the respective displacement of the plurality of components of the work machine (for example, the boom 4, the arm 5 and the bucket 6), (for instance, sensors which detect the stroke of the hydraulic cylinder) are installed respectively on the components. The coordinates of the bucket 6 are identified on the basis of the displacement of the respective components of the work machine detected by the displacement sensors of the work machine, the structure of the work machine, and the shape of the bucket 6.

The operator is able to carry out excavation of the construction surface 15 while observing the display image, such as the example shown in FIG. 14. During the excavation work, the operator may wish to see the positional error between the virtual line 23 and the construction surface 15 in an enlarged view, in order to achieve accurate excavation. Therefore, the display data creation unit 110 shown in FIG. 5 has a function for displaying the positional error between the virtual line 23 and the construction surface 15 in an enlarged form, in other words, an emphasized fashion, in the region of the display screen designated by the operator.

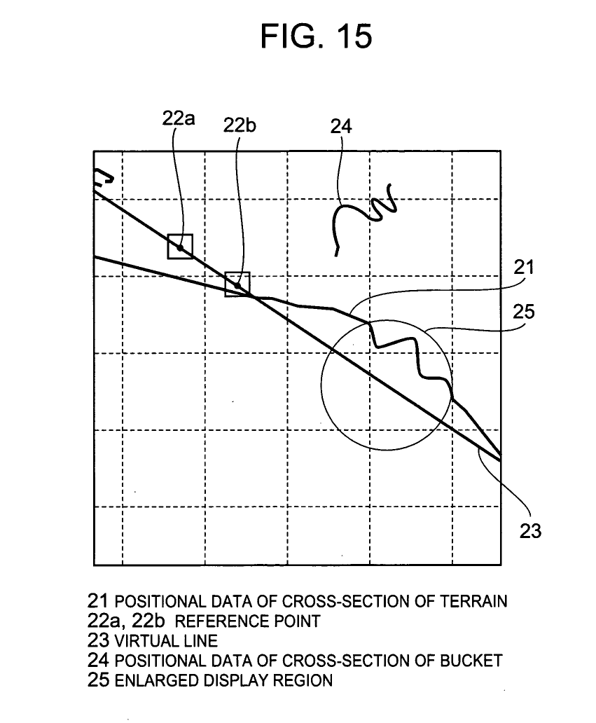

FIG. 15 shows an example of an image where error of this kind is displayed in an emphasized fashion in this way. In FIG. 15, in the enlarged display region 25, the undulations in the cross-sectional shape of the terrain 21, in other words, the error with respect to the virtual line 23, is displayed in an enlarged or emphasized fashion.

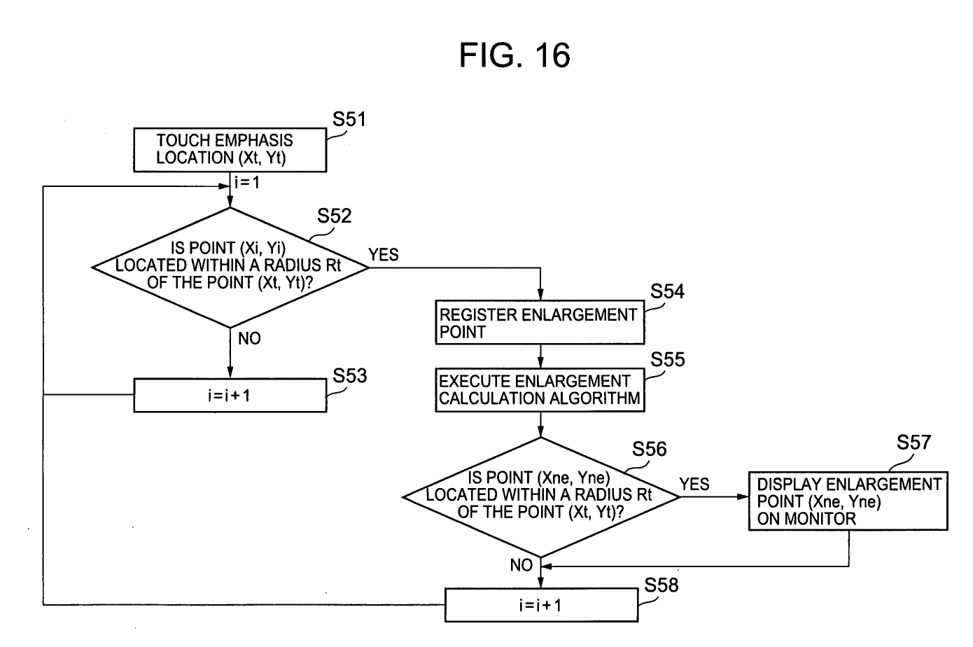

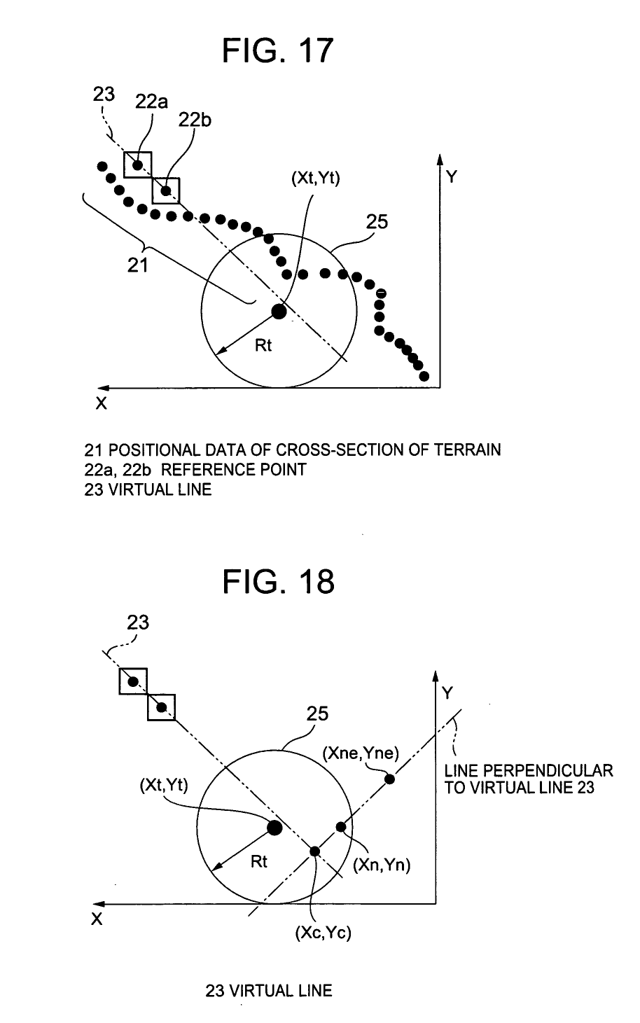

FIG. 16 shows an algorithm of processing for providing an emphasized display, as performed by the display data creation unit 110. FIG. 17 and FIG. 18 are diagrams for describing this algorithm.

At step S51 in FIG. 16, if the operator designates by means of the input device 36 a desired emphasis location (Xt, Yt) on the display screen (FIG. 17), then the processing from steps S52 to S58 is implemented by the display data creation unit 110.

At step S52, taking i as i=1, a judgment is made indicating whether or not the ith set of terrain coordinates (Xi, Yi) which correspond to the construction surface 15 (in other words, coordinates which do not correspond to the bucket 6 or to the reference points 22a and 22b), are located within a radius Rt of the designated emphasis location (Xt, Yt). Here, the radius Rt centered on the emphasis location (Xt, Yt) corresponds to the enlarged display region 25 illustrated in FIG. 15. If the terrain coordinates (Xi, Yi) are not located within this enlarged display region 25, then i is set to i=i+1, and the processing in step S52 is repeated until terrain coordinates (Xi, Yi) are found which are located within the enlarged display region 25.

If terrain coordinates (Xi, Yi) are found within the enlarged display region 25, then the terrain coordinates (Xi, Yi) are registered as an enlargement point (Xn, Yn) (step S54), and the enlargement calculation algorithm in step S55 is carried out with respect to this enlargement point (Xn, Yn).

In the enlargement calculation algorithm in step S55, as shown in FIG. 18, the virtual line 23 is set to Y=a*X+b, and the straight line which passes through the enlargement point (Xn, Yn) perpendicularly to the virtual line 23, and its point of intersection with the virtual line 23 (Xc, Yc), are determined by means of the following equations (in the equations given below, the symbol indicates multiplication.)
Xc=(Xn+a*Yn−a*b)/(a*a+1)
Yc=(a*Xn+a*a*Yn+b)/(a*a+1)

Therefore, the enlarged coordinates (Xne, Yne) obtained from the enlargement point (Xn, Yn) using a previously established enlargement factor E is calculated by:
Xne=(E*Xn−(E−1)*Xc
Yne=E*Yn−(E−1)*Yc

The enlarged coordinates (Xne, Yne) are displayed only if the enlarged coordinates (Xne, Yne) are positioned within the enlarged display region 25 (steps S56 and S58). The processing in steps S54 to S57 is repeated with respect to all of the terrain coordinates (Xi, Yi) found within the enlarged display region 25.

As a result of the aforementioned processing, an image which shows an enlarged or emphasized view of a portion of the cross-sectional image of the terrain, such as that in FIG. 15, is displayed. By observing this emphasized image while performing the excavation work for the construction surface, the operator is able to form a sloped surface which coincides with the virtual line 23 to a high degree of accuracy.

According to the embodiment of the present invention as described above, the distance measurement device 20 is disposed in a position at which it is able to maintain a uniform positional relationship with respect to the work machine in the direction of rotation, at all times, for example, a position on the operator's cabin, and furthermore, the distance measurement device 20 measures the substantially real-time positions of the construction surface, the reference markers and the bucket, by performing scanning continuously. Therefore, even if the hydraulic shovel 1 moves in a direction that is not parallel to the cords 17, it is still possible to display the current construction surface and a virtual line representing the target sloped surface, on the display screen.. Accordingly, the operator is able readily to perform excavation work of high accuracy.

If the reference points are detected automatically, then an object located in a position that is separated spatially from the construction surface is detected to be a reference point. Therefore, it is possible to detect the reference points automatically and to set the virtual line automatically, by placing reference markers, such as stakes, in the work site at positions that are separated spatially from the construction surface.

The cross-sectional shape of the inner surfaces of the bucket measured by the distance measurement device is corrected by an offset amount corresponding to the previously established bucket thickness, in such a manner that it corresponds approximately to the cross-sectional shape of the outer surfaces of the bucket. The cross-sectional shape of the outer surfaces of the bucket corrected in this fashion is displayed together with the cross-sectional shape of the construction surface. Therefore, the operator is able to ascertain, accurately, how to excavate the construction surface by means of the bucket.

Furthermore, the positional error between the virtual line and the construction surface is displayed in an enlarged, or emphasized, fashion, as and when necessary. Therefore, the operator is able to perform excavation more accurately.

The aforementioned embodiment was described with respect to an example where excavation work is performed in order to create a sloped surface, but the present invention may also be applied to excavation work for a purpose other than that of forming a sloped surface. Furthermore, the construction target indicator device according to the present invention is not limited to machines performing excavation work, and may also be applied to other machines which perform work with reference to the positional relationship between a cross-sectional shape and a desired virtual line, for example, a device which investigates the amount of projection of a building, or the like. The construction target indicator device according to the present invention may be incorporated as a part of the work machine when the work machine is manufactured, or alternatively, it may be provided as a product that is separate from the work machine, in such a manner that it can be attached to the work machine in a simple fashion. In either case, by adopting the construction target indicator device according to the present invention, it is possible to carry out accurate work, even using a work machine which is not provided with a control device such as that disclosed in Japanese Patent Laid-open No. 5-295754 or Domestic Re-publication of International Publication No. WO98/036131.

An embodiment of the present invention was described above, but this embodiment is merely an example for the purpose of describing the present invention, and the scope of the present invention is not limited to this embodiment alone. The present invention may be implemented in various other modes, without deviating from the essence of the invention.

1. A device (30) for giving indications to the operator of a work machine, characterized in comprising:
a measurement device (20) for measuring the position of a construction surface, which is a current work object, and the position of other objects located in the vicinity of said construction surface, while said work machine is performing work;
a reference point detection unit (102) for detecting reference points corresponding to reference markers disposed in the vicinity of said construction surface, from the positions of the construction surface and the other objects measured by said measurement device;
a virtual line calculation unit (104) for calculating a virtual line corresponding to a target surface that is to be formed, on the basis of said reference points detected by said reference point detection unit;
a display data creation unit (110) for creating display data for displaying images indicating the positions of at least said construction surface and said virtual line, on the basis of said positions measured by said measurement device and said virtual line calculated by said virtual line calculation unit; and
a display device (34) for receiving said display data from said display data creation unit and displaying said images on a display screen.

2. The device according to claim 1, characterized in that said display data creation unit (110) creates said display data in such a manner that an image which also depicts the position of said other objects in addition to the positions of said construction surface and said virtual line is displayed.

3. The device according to claim 1, characterized in that said measurement device (20) is disposed in such a manner to move or turn direction in unison with said work machine, when said work machine moves or turns direction, whereby, even if said construction surface moves due to said work machine moving or turning direction, the positions of said construction surface and the other objects located in the vicinity of said construction surface are measured and an image indicating the positions of said construction surface and said virtual line is displayed.

4. The device according to claim 1, characterized in that said measurement device (20) determines the positions of said construction surface and other objects on a continuous basis, whereby an image indicating the substantially real-time positions of said construction surface and said virtual line is displayed on the display screen.

5. The device according to claim 1, characterized in that said reference point detection unit (102) detects a position satisfying prescribed geometrical conditions, from the positions of said construction surface and other objects measured by said measurement device, as said reference point.

6. The device according to claim 1, characterized in that said reference point detection unit (102) detects a position specified by said operator, from the positions of said construction surface and other objects measured by said measurement device, as said reference point.

7. The device according to claim 1, characterized in that said reference point detection unit (102) detects a plurality of positions from the positions of said construction surface and the other objects measured by said measurement device, as said reference points; and
said virtual line calculation device (104) calculates said virtual line in such a manner that said virtual line passes through said plurality of reference points thus detected.

8. The device according to claim 1, characterized in further comprising: an acting component detection unit (106) for detecting the position of an acting component (6) which acts on said construction surface of said work machine;
wherein said display data creation unit (110) creates said display data in such a manner that an image which depicts the position of said acting component in addition to the positions of said construction surface and said virtual line, on the basis of the position of said acting component detected by said acting component detection unit.

9. The construction target indicator device according to claim 8, characterized in that said acting component detection unit (106) detects the position of said acting component from the positions of said construction surface and said other objects measured by said measurement device.

10. The device according to claim 9, characterized in further comprising an acting component position correction unit (108) for correcting the position of said acting component detected by said acting component detection unit, by means of a prescribed offset amount;
wherein said display data creation unit (110) creates said display data in such a manner that an image which depicts the corrected position of said acting component in addition to the positions of said construction surface and said virtual line, on the basis of the position of said acting component corrected by said acting component position correction unit, is displayed.

11. The device according to claim 1, characterized in that displacement sensors for measuring the displacement of a plurality of components of said work machine are provided in said work machine; and
said acting component detection unit (106) detects the position of said acting component on the basis of the displacement of said plurality of components measured by said displacement sensors.

12. The device according to claim 1, characterized in that said display data creation unit (110) creates emphasized display data for displaying an emphasized image which shows an enlarged view of the positional error between said construction surface and said virtual line, in response to a request from said operator; and
said display device (34) displays said emphasized image by receiving said emphasized display data from said display data creation unit.

13. A device (30) for giving indications to the operator of a construction machine having a work machine, characterized in comprising:
a measurement device (20), which is installed on said construction machine in such a manner that said measurement device moves or turns direction in unison with said work machine, when said construction machine moves or said work machine turns direction, and which measures the positions of the construction surface forming the current work object and other objects located in the vicinity of said construction surface, while said work machine is performing work;
a reference point detection unit (102) for detecting reference points corresponding to reference markers disposed in the vicinity of said construction surface, from the positions of the construction surface and the other objects measured by said measurement device;
a virtual line calculation unit (104) for calculating a virtual line corresponding to a target surface that is to be formed, on the basis of said reference points detected by said reference point detection unit;
a display data creation unit (110) for creating display data for displaying images indicating the positions of at least said construction surface and said virtual line, on the basis of said positions measured by said measurement device and said virtual line calculated by said virtual line calculation unit; and
a display device (34) for receiving said display data from said display data creation unit and displaying said images on a display screen.

14. A method for giving indications to the operator of a work machine, characterized in comprising the steps of:
measuring the position of a construction surface, which is a current work object, and the position of other objects located in the vicinity of said construction surface, while said work machine is performing work;
detecting reference points corresponding to reference markers disposed in the vicinity of said construction surface, from the measured positions of the construction surface and the other objects;
calculating a virtual line corresponding to a target surface that is to be formed, on the basis of said detected reference points; and
creating an image indicating the positions of at least said construction surface and said virtual line, on the basis of said measured position and said calculated virtual line, and displaying said image on the display screen.
